(19) United States
(12) Patent Application Publication
(10) Pub. No.: US 2019/0362491 A1
(43) Pub. Date: Nov. 28, 2019

(54) COMPUTER-IMPLEMENTED APPARATUS AND METHOD FOR PERFORMING A GENETIC TOXICITY ASSAY

(71) Applicant: Swansea University, Swansea (GB)

(72) Inventors: Paul REES, Swansea (GB); George JOHNSON, Swansea (GB)

(21) Appl. No.: 16/332,779

(22) PCT Filed: Sep. 13, 2017
(86) PCT No.: PCT/GB2017/052684

§ 371 Date: Mar. 12, 2019

(30) Foreign Application Priority Data
Sep. 13, 2016 (GB) 1615532.7

(51) Int. Cl. G06T 7/00; G06K 9/00; G06K 9/62; G01N 15/14

(52) U.S. Cl. CPC G06T 7/0012; G06K 9/00147; G06K 9/6256; G01N 2015/1006; G06T 2207/30024; G06T 2207/20081; G06T 2207/20084; G01N 15/1475

(57) ABSTRACT

A computer-implemented apparatus for performing a genotoxicity assessment in respect of a population of labelled cells pre-treated with, or exposed to, one or more specified substances, conditions and/or environments. The apparatus comprises a imaging flow cytometry system for capturing image files representative of said cell population, wherein each image file is representative of a single cell of said population, a cell-image analysis module configured to receive said image files and generate, in respect of each one thereof, respective cytological profiles; and a machine learning module configured to receive said cytological profiles and, in respect of each of a plurality thereof obtain therefrom one or more characteristics and insert their respective value(s) into a predetermined algorithm to generate a classifier and compare said generated classifier with a predetermined rule to output a score for the respective cell.

### FIELD OF THE INVENTION

This invention relates generally to a computer-implemented apparatus and method for performing a genetic toxicity assay and, more particularly but not necessarily exclusively, to such a computer-implemented apparatus and method for performing a genetic toxicity assay by identifying DNA damage to cells, and/or measuring the extent of such DNA damage, on the basis of micronuclei formation.

### BACKGROUND OF THE INVENTION

It is well-established, particularly in the drug discovery and development industry, to employ genotoxicity testing in the safety assessment of all types of substances, especially drugs. Early toxicity screening assays have been developed that are intended to identify and, if necessary, eliminate any leads in development that are too toxic for therapeutic purposes. A number of assays are known for use in this process, such as the in vitro micronucleus test which measures a key endpoint in the battery of assays that have regulatory acceptance.

The in vitro (mammalian cell) micronucleus test is a genotoxicity test for the detection of micronuclei in the cytoplasm of interphase cells. Micronuclei may originate from acentric chromosome fragments (i.e. lacking a centromere), or whole chromosomes that are unable to migrate to the poles during the anaphase stage of cell division. Micronucleus induction is a key characteristic of genotoxic compounds and micronucleus testing enables the analysis of micronuclei formation from DNA strand breakage (clastogens) or interference with chromosome segregation (aneugins), wherein the above-mentioned assays detect the activity of clastogenic and aneugenic test substances in cells that have undergone cell division during or after exposure to the test substance. This is a heavily regulated process, and detailed regulatory guidelines can be found in the OECD Guideline for the Testing of Chemicals, Section 4, Test No. 487, in vitro Mammalian Cell Micronucleus Test, September 2014.

As part of the in vitro micronucleus testing process, cells exhibiting DNA damage are scored by one or more of a number of known methods. For example, cells can be scored manually (by viewing a series of slides using a microscope), which is clearly highly laborious and inefficient. Other scoring methods utilise flow cytometry, in which chromatin from cells undergoing apoptis/necrosis is initially stained with a light activated, fluorescent, nucleic acid-binding cell permeability stain, following which the cells are lysed to liberate the nuclei and micronuclei and then the total DNA content is labelled with a second fluorescent nucleic acid stain. Finally, each chemical dose is scored for the induction of micronuclei using a flow cytometer. However, this technique is highly labour intensive and known to give rise to misleading positive or negative outputs due to over- or under-scoring respectively of cells.

Furthermore, lysing cells can introduce artefacts that may mask or interfere with the micronucleus analysis.

Another known higher-throughput approach utilises semi-automated microscopy-based image classifiers to score cells. However, once again, such techniques are known to give rise to misleading positive or negative outputs.

In general, the main challenges with in vitro tests, including the above-mentioned micronucleus test, are related to the high number of false positives that are reported, especially when using mammalian cells. In this context, false positives are found by subsequent animal testing which does not confirm the genotoxicity of a substance reported as a result of in vitro studies. Thus, known in vitro genotoxicity assessment methods currently give rise to unnecessary animal testing and/or the abandonment of promising substances that might otherwise be safe. From a commercial perspective, unnecessary costs may be incurred, either due to superfluous animal testing or early compound discontinuation.

It would, therefore, be desirable to provide an apparatus and method for performing in vitro micronucleus testing, that can support high-throughput screening, and that offers the speed, sensitivity and phenotyping abilities of flow cytometry, coupled with the detailed imagery and functional insights of manual scoring techniques using microscopy, without the need to lyse analysed cells. Aspects of the present invention seek to address at least some of these issues.

### SUMMARY OF THE INVENTION

In accordance with a first aspect of the present invention, there is provided a computer-implemented apparatus for performing a genotoxicity assessment in respect of a population of labelled cells pre-treated with, or exposed to, one or more specified substances, conditions and/or environments, the apparatus comprising:
a imaging flow cytometry system for capturing image files representative of said cell population, wherein each image file is representative of a single cell of said population;
a cell-image analysis module configured to receive said image tiles and generate, in respect of each one thereof, respective cytological profiles; and
a machine learning module configured to receive said cytological profiles and, in respect of each of a plurality thereof:
   obtain therefrom one or more characteristics and insert their respective value(s) into a predetermined algorithm to generate a classifier; and
   compare said generated classifier with a predetermined rule to output a score for the respective cell.

In an exemplary embodiment, the apparatus may further comprise a data storage module for receiving and storing said image files, thus enabling the data collected from the cell samples to be kept and re-used as required.

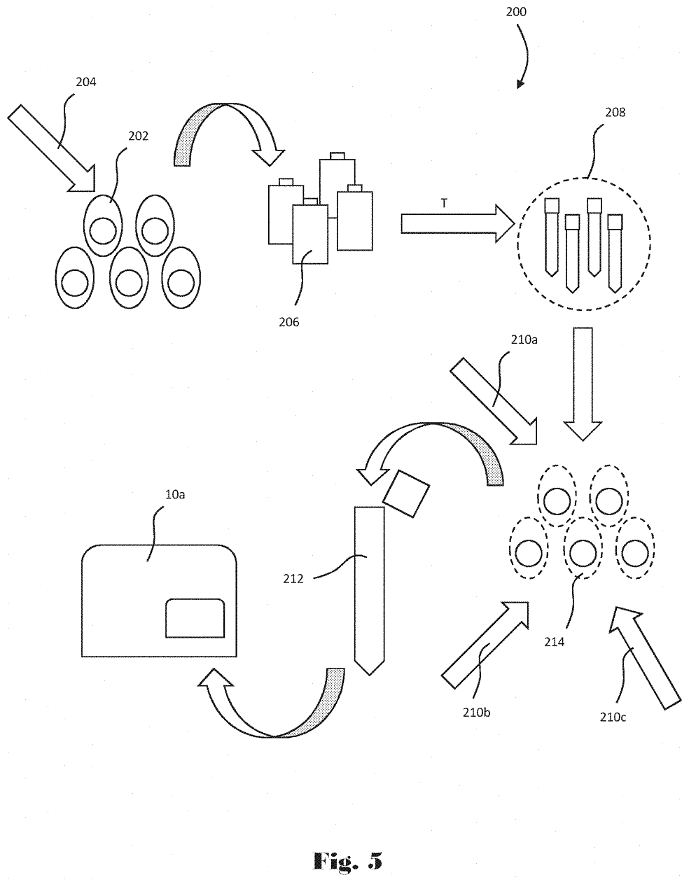

The imaging flow cytometry system may comprise a plurality of detection channels, each detection channel being configured to output a different image of a single cell, and wherein each image file may comprise a set of images of a single cell acquired from a plurality of said detection channels. Thus, for example, the imaging flow cytometry system may output, from a plurality of channels (and in respect of a single cell) a plurality of TIFF images, e.g. bright-field, dark-field, fluorescence, scatter, etc., and these TIFF files may then be stored together as a CIF file for: a) input to the cell-image analysis module, and b) future re-use. In an exemplary embodiment, each image file may further include an image comprising a combination of at least two images of said single cell. For example, the bright-field and fluorescence images may be combined to create a composite image (such as those illustrated in FIG. 4 of the drawings) so as to allow for clear analysis of nuclear bodies, and wherein the inclusion of the bright-field image (during analysis) provides the ability to distinguish single cell events from clumped/multiple cell image capture.

The algorithm may, for example, comprise an adaptive boosting algorithm, or a deep learning algorithm such as a deep convolutional network.

In an exemplary) embodiment, the apparatus may further comprise a data processing module for compressing or otherwise re-formatting said image files for export to said cell-image analysis module.

Optionally, the cytological profile generated in respect of each cell represented in a respective image file comprises or includes a value representative of a specified event.

The genotoxicity assessment may be an in vitro micronucleus test and said cells are mammalian cells. In this case, the above-mentioned specified event may be micronucleus induction.

The above-mentioned predetermined rule may be configured to give a positive score for a cell if the classifier generated therefor is greater than a predetermined value and a negative score if said classifier is less than a predetermined value. In this case, the predetermined value may be representative of a likelihood of the existence in a respective cell of a micronucleus distinct from its principal nucleus.

In an exemplary embodiment, the cell-image analysis module may be configured, in respect of each cytological profile, to remove or otherwise exclude irrelevant cell characteristics therefrom prior to output thereof to said machine learning module.

In accordance with another aspect of the present invention, there is provided a computer-implemented method for performing a genotoxicity assessment in respect of a population of labelled cells pre-treated with, or exposed to, one or more specified substances, conditions and/or environments, the method comprising:
using a flow imaging cytometry system to capture image files representative of said cell population, wherein each image file is representative of a single cell of said population;
using a cell-image analysis module to receive said image tiles and generate, in respect of each one thereof, respective cytological profiles; and
using a machine learning module to receive said cytological profiles and, in respect of each of a plurality thereof:
   obtain therefrom one or more characteristics and insert their respective value(s) into a predetermined algorithm to generate a classifier; and
   compare said generated classifier with a predetermined rule to output a score for the respective cell.

The method may further comprise the step of compressing or otherwise re-formatting said image files for export to said cell-image analysis module.

In an exemplary embodiment, the method may further comprise the step of training said machine learning module to perform said comparing step by:
obtaining a plurality of pre-scored image files representative of respective single cells;
using said cell-image analysis module to generate respective cytological profiles in respect of said pre-scored image files; and
inputting said cytological profiles into said machine learning module together with associated data representative of a score assigned to the respective cells represented in said image files.

### DETAILED DESCRIPTION

These and other aspects of the present invention will become apparent from the following specific description, in which embodiments of the invention are described, by way of examples only, and with reference to the accompanying drawings, in which:

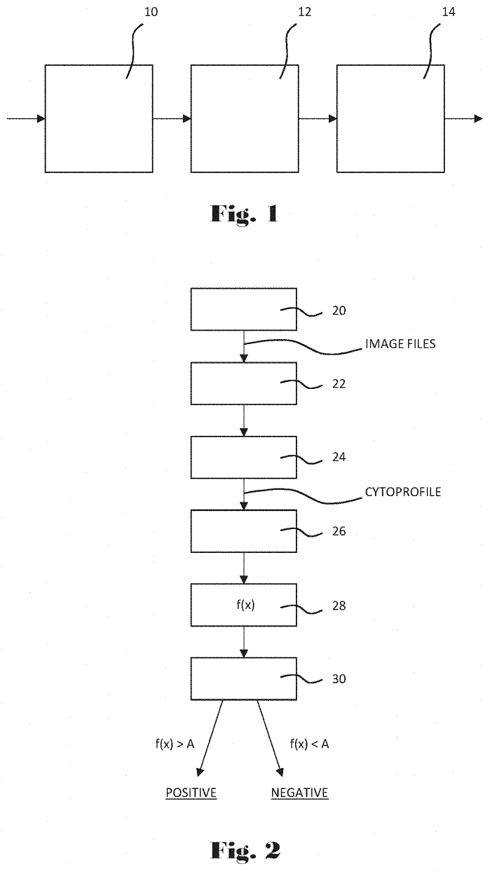

FIG. 1 is a schematic block diagram illustrating principal features of an apparatus according to a first exemplary embodiment of the present invention.

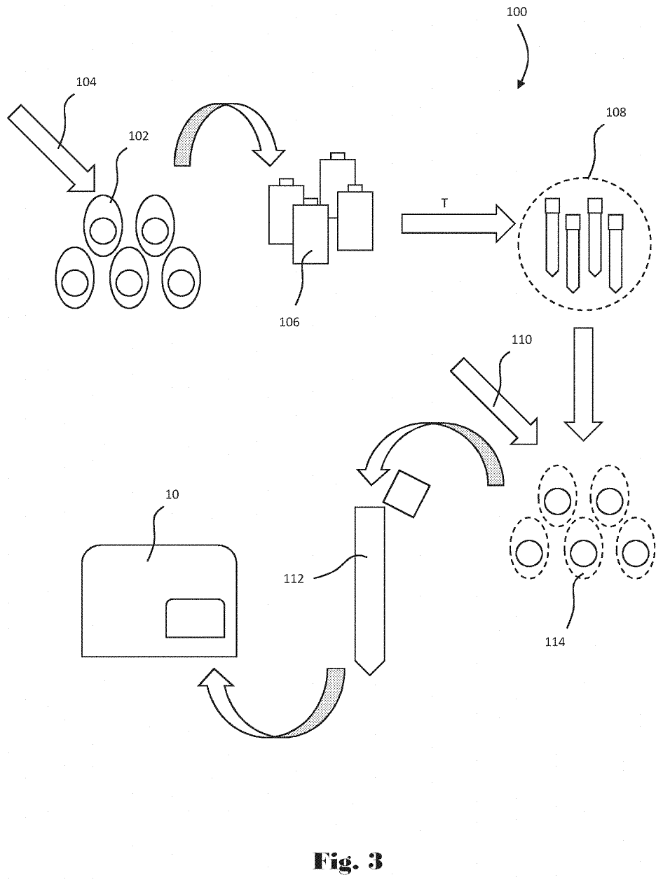

FIG. 2 is a schematic flow diagram of a method according to a first exemplary embodiment of the present invention;

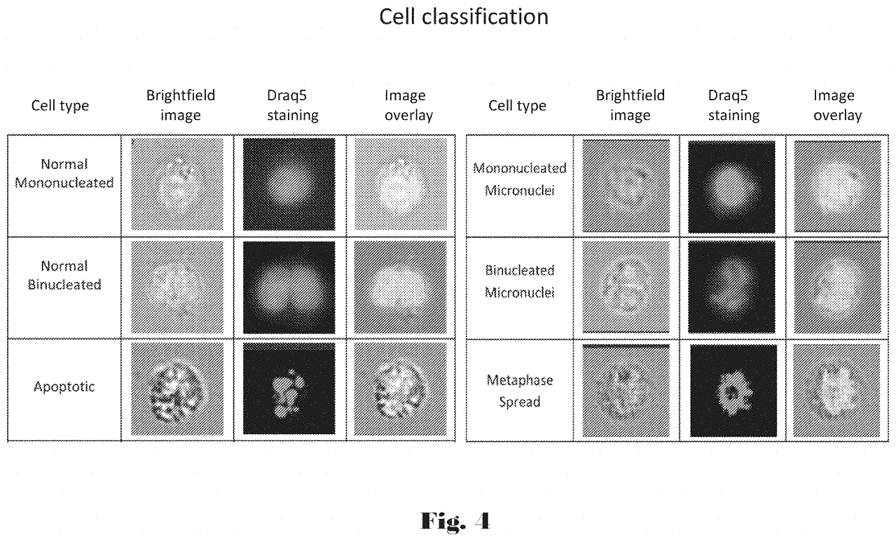

FIG. 3 is a schematic diagram illustrating a cell preparation process for input to an imaging flow cytometry device for use in a first exemplary embodiment of the present invention;

FIG. 4 is illustrative of TIFF images generated by an imaging flow cytometry device used in a first exemplary embodiment of the present invention; and,

FIG. 5 is a schematic diagram illustrating a cell preparation process for input to an imaging flow cytometry device for use in a second exemplary embodiment of the present invention.

### FIRST EMBODIMENT

Thus, referring first to FIG. 1 of the drawings, apparatus according to an exemplary embodiment of the present invention comprises an imaging flow cytometer device 10, a cell-image analysis module 12 and a machine learning module 14.

Imaging flow cytometry devices are known in the art. For example, U.S. Pat. No. 6,249,341 describes a known imaging flow cytometer in the form of an imaging system for producing images of cells that are conveyed by a fluid flow through the imaging system. Fluid flow entrains each cell and carries it through the imaging system. Light from the cell passes through collection lenses that collect the light. Collected light then enters, for example, a prism which disperses the light, and the dispersed light then enters imaging lenses which focus light onto a TDT (Time Delay Integration) detector Various optical magnifications can be used to achieve a desired resolution of a cell that is being imaged light sensitive regions (pixels) of the TDI detector. In one embodiment, the magnification is 20×. In an exemplary embodiment of the present invention, the imaging flow cytometry device 10 may comprise, for example, ImageStream® manufactured by Amnis®, but the present invention is not intended to be in any way limited in this regard.

In at least some known imaging flow cytometry devices, image analysis and acquisition software is provided and the raw image data output from the imaging system may be processed thereby. For example, the image flow cytometry device 10 of the present invention may incorporate, or be communicably coupled to, image analysis and acquisition software such as IDEAS® created by Amnis®, although the present invention is not intended to be in any way limited in this regard. The raw image data output by the above-described imaging system may be processed by the image analysis and acquisition software to generate a gallery of images of individual cells (as illustrated, for example, in FIG. 4 of the drawings), which may be saved in any file format, such as TIFF. This raw image data can, in some cases, be exported directly into the cell-image analysis module 12 but, in other cases, it may be necessary to compress or otherwise reduce the size of the image files before importing them into the cell-image analysis module 12, depending on the ability of the specific cell-image analysis module employed to manage larger data files and, of course, the format of the raw image data generated by the image analysis and acquisition software.

As explained above, an in vitro micronucleus assay, which is a well known test to detect agents which modify chromosome structure and segregation in such a way as to lead to induction of micronuclei in inter-phase cells, cell cultures are exposed to the test substance both with and without metabolic activation. After exposure to the test substance (and, in some cases, cytochlasin B for blocking cytokinesis), cell cultures are grown for a period sufficient to allow chromosomal damage to lead to formation of micronuclei in bi- or multinucleated interphase cells.

An exemplary cell preparation process 100 is illustrated schematically in FIG. 3 of the drawings. As illustrated, human lymphoblastoid TK6 cells 102 are placed in tissue culture flasks 106 with a test substance (chemical 104) and incubated for a period of time (‘treatment period’=T). In this embodiment, the treatment time T is 30 hours for mononucleated assay, and 4 hours before a 21 hour dose with e.g. CytoB for a binucleated assay.

After the treatment period T, cultures are centrifuged, washed with e.g. PBS, HIHS media and re-suspended, and treated with FacsLyse solution to permeabalise the cells (these steps shown figuratively at 108). The permeabalised cells are then stained with a stain 110 (e.g. Draq5) and the harvested and stained interphase cells 114 are transferred to suitable containers 112, for example, Eppendorf tubes.

Referring to FIG. 2 of the drawings, the harvested and stained inter-phase cells 114 are then passed through the imaging flow cytometry device 10 (step 20) and image acquisition package of the type described above to generate a gallery of image files representative of the imaged cells. The harvesting and labelling of cells for this purpose, to obtain images thereof using an imaging flow cytometry system, will be familiar to a person skilled in the art and will not be described in any further detail herein. It will be understood by a person skilled in the art that a number of different assays may be used, including the conventional cytokinesis blocked assay, the conventional non-cytokinesis blocked assay and the cytome assay described in “Cytokinesis block micronucleus cytome assay”, Nature Protocols (5), pp. 1084-1104, Nature Protocols 2007, and the present invention is not necessarily intended to be in any way limited in this regard. Equally, many different types of imaging flow cytometry systems will be known to a person skilled in the art, and the present invention is not necessarily intended to be limited in this regard.

Suffice it to say that, as a result of the imaging flow cytometry process outlined above, a gallery of image files representing the imaged cells is acquired. Each image file contains an image of a single cell, acquired from one of a number of channels supported by the imaging flow cytometry device (e.g. scatter, bright-field, dark-field, fluorescence, etc.). As illustrated in FIG. 4 of the drawings, different cell types can be captured in this manner, and the images can also be combined to allow for a clear analysis of nuclear bodies (i.e. to make sure an MN induced are true MN as they lie within the boundary of the cell membrane. In FIG. 4 it can be seen that the fluorescence and bright-field images of a single cell can be combined, wherein the inclusion of the bright-field image for cell analysis improves the ability to distinguish single cell events from clumped/multiple cell image capture.

Next the image files, in their raw data format or compressed or otherwise reduced in size or re-formatted as required, are exported to the cell-image analysis module 12 (at step 22). In one specific exemplary embodiment, the TIFF files generated by the imaging flow cytometry device 10 may be stored within a CIF file container and input to the cell-image analysis module 12 as a .cif file via a ‘drag and drop’ interface. Cell-image analysis software is known and an example of such software is known as CellProfiler (cellprofiler.org). Cell-image analysis software of this type is configured to generate (step 24) a cytological profile, or cytoprofile, for each cell (from its respective image file including bright-field and fluorescence images). In general, a cytoprofile, thus generated, consists of a set of numbers that describe the cell's characteristics or features including, for example, size, shape and the intensity and texture of various stains in various compartments. In one exemplary embodiment, a script is used to read the above-mentioned .cif file and writes respective image montages to a disk or other storage medium. The montages are then loaded into the cell-image analysis module 12 and a pipeline is run to measure hundreds of features in bright-field and dark-field. The pipeline then exports the measurements (e.g. as a csv file), which can be used for downstream data analysis (i.e. machine learning). In addition, the pipeline exports a properties file, which includes a section where features can be excluded from the cytoprofile (as irrelevant).

In the case of the present invention, the specific cell characteristics or features required from the cytoprofile can be considered to be weak classifiers (and indicative of rare events such as micronucleus induction), and these will be known to a person skilled in the art. For example, features such as location or orientation of the cells may be excluded as irrelevant.

Thus, once the cytoprofile of each imaged cell has been generated, and the respective ‘irrelevant’ characteristics or features have been extracted therefrom (step 26), the properties file can be loaded into the machine learning module 14, which may utilise an adaptive boosting machine learning algorithm. In one embodiment, the machine learning module uses an artificial neural network (ANN). For example deep neural networks which have many cascade inter-connected layers of nonlinear processing nodes have been shown to be ideal for image recognition tasks and are also used for cell phenotype identification could be used to classify micronucleus events. Again under-sampling would be used and the architecture of the network optimized for the particular task of finding the rare micronuclear events.

In general, a boosting algorithm builds a boosting classifier f(x) by taking a combination (e.g. a linear combination) of so-called weak classifiers to form a more robust classifier to generalise a data set D. In the context of the present invention, the data set D would be the cell population and the value of the classifier for each cell will be used to “score” the cell against a given criterion. Many such boosting algorithms will be known to a person skilled in the art, and the present invention is not intended to be limited as to the specific boosting algorithm used. However, by way of example only, a booting algorithm that may be used is known as RUS (Random Under Sampling)Boost. RUSBoost is a known boosting algorithm that is especially effective at classifying imbalanced data, meaning some class in the training data has many fewer members than another. The algorithm, which will be familiar to a person skilled in the art, takes N, the number of members in the class with the fewest members in training data, as the basic unit for sampling. Classes with more members are undersampled by taking only N observations of every class. The boosting algorithm, once constructed, can be used to generate a value (step 28) for the classifier fix) in respect of each cell (using the values of the weak classifiers for that cell, as mentioned above). Once the value of f(x) has been determined for a cell, that cell can be scored (step 30) according to some predetermined criterion. Scoring of this type may take many forms, but in an exemplary embodiment, the scoring output provides an indication, in the case of each analysed cell, whether or not it has a viable micronucleus (i.e. is there a spot distinct from the large nucleus clearly visible?).

Of course, as will be known to a person skilled in the art, in order for the adaptive machine learning process to be effective, the scoring element thereof must be ‘trained’. Thus, training of the machine learning algorithm must first be undertaken before it can be used to classify or ‘score’ a population of cells under test. Training, in its simplest form, may comprise manual classification of a set of ‘positive’ cells (i.e. having a viable micronucleus) and a set of ‘negative’ cells (i.e. those not having a viable micronucleus), inputting images of these cells into the machine learning algorithm and identifying them as positive or negative depending on the value of the classifier calculated by the boosting algorithm in each case. In this way, the algorithm ‘learns’ the rules for classifying a cell as positive or negative. The larger the sets of cells used as training data, the more accurate will be the resultant analysis. The manner in which such training can be achieved will be familiar to a person skilled in the art, and will not be discussed further herein.

Thus, it will be apparent from the foregoing that, by utilising single cell images, acquired from an imaging flow cytometry system, to perform the cell-image analysis, and then using weak classifier values from the resultant cytoprofile in an adaptive boosting machine learning process to ‘score’ the data set (cell population), results in an integrated process with significantly more accurate results than current processes, with more and better information about the cell population, and individual cells thereof, thus being made available. As a consequence, the likelihood of false positives resulting from the testing process are minimised and the associated disadvantages thereof avoided.

### Experiment

The applicants have carried out the following test of the invention.

Human lymphoblastoid TK6 and metabolically active MCL-5 cells were treated with Methyl Methane Sulfonate (MMS), Carbendazim and Benzo[a] Pyrene (B[a]P) respectively for a period of 1.5 cells cycles. Cells were fixed, nuclei and MN stained with DRAQ5. MN scoring was carried out by using a 20× magnification on an imaging cytometer (FlowSight®) equipped with a 488 nm laser and 12 channels for multi-parametric analysis. INSPIRE® software was used for gating dead cells/debris and IDEAS® image analysis tool was used for scoring bi-nucleated cells with and without MN. Manual scoring was carried out in conjunction to imaging flow cytometry analysis to assess the reproducibility of the results. A total of 3000 bi-nucleated cells were scored manually using both these approaches.

The MN frequencies derived using ImageStream were comparable to the MN responses derived using manual microscopy scoring in TK6 and MCL-5 cells treated with MMS, Carbendazim and B[a]P. Images of 10,000-100000 images of whole cells suitable for archiving can be acquired within minutes, without the need of cell lysis. The CBMN ImageStream protocol can be adopted for MN in the absence of Cyto-B. In conclusion, ImageStream MN scoring platform is suitable for in vitro MN scoring in cells with and without metabolic activation, and has a potential to be an automated MN scoring for the MN assay.

### SECOND EMBODIMENT

It is envisaged that the platform provided by exemplary embodiments of the present invention provides the potential for use of multiplexing the assay. For example, with centromere/kinetochore probes, and analysis of additional genotoxic end points, such as γ-H2AX analysis, which identifies double strand breaks as well as providing data on the cell cycle.

With this in mind, a further embodiment of the invention is shown in FIG. 5. In this Figure, a cell preparation process 200 is provided being similar to the process 100 with reference numerals for common features being 100 greater. Instead of a single stain 110, a plurality of stains 210a. 210b, 210c are added to the cells. The stains may be added sequentially or simultaneously. Each stain is chosen to indicate a specific type of cell damage, for example oxidative stress, DNA strand breaks, DNA adducts, DNA repair pathways and cell cycle perturbations.

An example combination of stains is:
AlexaFluora 488 H3
DRAQ5
BV421 γ-H2AX

As with the process 100, in the process 200 the harvested and stained interphase cells 214 are transferred to suitable containers 212, and passed through an imaging flow cytometry device 10a (step 20 of FIG. 2). The imaging flow cytometry device is configured to generate images in which the individual stains can be recognised. In this embodiment, the imaging flow cytometry device 10a excites each stain using a different laser, and therefore generates at least one image per stain. The image acquisition package of the type described above generates a gallery of image files representative of the imaged cells.

The inventors have achieved clear advantages with the embodiments described above compared with conventional manual and semi-automated methods (referenced above), namely the ability to quickly, accurately and consistently assess many images at once, as well as the ability to save sample images. Through the use of templates on the analysis software, collection of cellular events to exclude bodies under 50 in size and debris has been achieved. In an exemplary embodiment, experimental results have demonstrated the ability to capture between 150 and 1000 events per second to achieve a collection of 10,000 true events, thereby demonstrating the high-throughput high-content capacity. As well as this, aspects of the present invention provide the ability to analyse the same sample multiple times, which cannot be done using conventional assays, plus the additional advantage of direct image capture of the events. A further advantage of the present invention over conventional systems arises due to the lack of cell lysing, and yet another advantage is provided because the software allows for specific gating based on single cell morphology and focus, thus allowing for the extraction of specific cell populations from within the raw data file, enabling exclusion of clumped cells and debris and, thereby, further improving the accuracy of the overall system.

Overall, a principal problem associated with conventional genetic toxicity assays has been the inability to process a large number of cells at once quickly and efficiently, whilst minimising the likelihood of false positives. By applying the above-described techniques, it is possible to combine an imaging flow cytometry device with a cell-image analysis module and machine learning module to enable a very high throughput genetic toxicity assay to be provided, in which false positives are minimised and accuracy and reliability is significantly and unexpectedly improved, whilst providing the additional benefit of enabling samples to be re-analysed.

It will be appreciated by a person skilled in the art, from the foregoing description, that modifications and variations can be made to the described embodiments, without departing from the scope of the invention as defined by the appended claims.

1. Computer-implemented apparatus for performing a genotoxicity assessment in respect of a population of labelled cells pre-treated with, or exposed to, one or more specified substances, conditions and/or environments, the apparatus comprising:
a imaging flow cytometry system for capturing image files representative of said cell population, wherein each image file is representative of a single cell of said population;
a cell-image analysis module configured to receive said image files and generate, in respect of each one thereof, respective cytological profiles; and a machine learning module configured to receive said cytological profiles and, in respect of each of a plurality thereof:
obtain therefrom one or more characteristics and insert their respective value(s) into a predetermined algorithm to generate a classifier; and compare said generated classifier with a predetermined rule to output a score for the respective cell.

2. Apparatus according to claim 1, comprising a data storage module for receiving and storing said image files.

3. Apparatus according to claim 1, wherein said imaging flow cytometry system comprises a plurality of detection channels, each detection channel being configured to output a different image of a single cell, and wherein each image file comprises a set of images of a single cell acquired from a plurality of said detection channels.

4. Apparatus according to claim 3, wherein each image file further includes an image comprising a combination of at least two images of said single cell.

5. Apparatus according to claim 1, wherein said algorithm is an adaptive boosting algorithm.

6. Apparatus according to claim 1, wherein said algorithm comprises a deep learning algorithm.

7. Apparatus according to claim 6, wherein said algorithm comprises a deep convolutional network.

8. Apparatus according to claim 1, further comprising a data processing module for compressing or otherwise re-formatting said image files for export to said cell-image analysis module.

9. Apparatus according to claim 1, wherein said cytological profile generated in respect of each cell represented in a respective image file comprises or includes a value representative of a specified event.

10. Apparatus according to claim 9, wherein said genotoxicity assessment is an in vitro micronucleus test and said cells are mammalian cells.

11. Apparatus according to claim 10, wherein said specified event is micronucleus induction.

12. Apparatus according to claim 10, wherein said predetermined rule is configured to give a positive score for a cell if the classifier generated therefor is greater than a predetermined value and a negative score if said classifier is less than a predetermined value.

13. Apparatus according to claim 12, wherein said predetermined value is representative of a likelihood of the existence in a respective cell of a micronucleus distinct from its principal nucleus.

14. Apparatus according to claim 1, wherein said cell-image analysis module is configured, in respect of each cytological profile, to remove or otherwise exclude irrelevant cell characteristics therefrom prior to output thereof to said machine learning module.

15. A computer-implemented method for performing a genotoxicity assessment in respect of a population of labelled cells pre-treated with, or exposed to, one or more specified substances, conditions and/or environments, the method comprising:
using a flow imaging cytometry system to capture image files representative of said cell population, wherein each image file is representative of a single cell of said population;
using a cell-image analysis module to receive said image files and generate, in respect of each one thereof, respective cytological profiles; and
using a machine learning module to receive said cytological profiles and, in respect of each of a plurality thereof:
obtain therefrom one or more characteristics and insert their respective value(s) into a predetermined algorithm to generate a classifier; and compare said generated classifier with a predetermined rule to output a score for the respective cell.

16. A method according to claim 15, further comprising compressing or otherwise reformatting said image files for export to said cell-image analysis module.

17. A method according to claim 16, further comprising training said machine learning module to perform said comparing step by:
obtaining a plurality of pre-scored image files representative of respective single cells;
using said cell-image analysis module to generate respective cytological profiles in respect of said pre-scored image files; and
inputting said cytological profiles into said machine learning module together with associated data representative of a score assigned to the respective cells represented in said image files.
